(19) United States
(12) Patent Application Publication
(10) Pub. No.: US 2026/0282017 A1
(43) Pub. Date: Sep. 17, 2026

(54) FULL POWER UPLINK TRANSMISSION MODE 1 FOR 8TX UE

(71) Applicant: LENOVO (BEIJING) LIMITED, Beijing (CN)

(72) Inventors: Chenxi Zhu, Beijing (CN); Bingchao Liu, Beijing (CN); Yi Zhang, Beijing (CN)

(21) Appl. No.: 19/167,973

(22) PCT Filed: Jul. 20, 2023
(86) PCT No.: PCT/CN2023/108287

§ 371 Date: Sep. 23, 2025

(51) Int. Cl. H04W 72/21; H04B 7/0456; H04W 72/232

(52) U.S. Cl. CPC H04W 72/21; H04B 7/0456; H04W 72/232

(57) ABSTRACT

Various aspects of the present disclosure relate to methods, apparatuses, and systems that support full power uplink transmission. Some implementations of the method and apparatuses described herein may further include a user equipment (UE) for wireless communication, comprising: at least one memory; and at least one processor coupled with the at least one memory and configured to cause the UE to: receive a DCI format 0_1 or 0_2 including a TPMI field, where the TPMI field contains PUSCH transmission scheme information, wherein, the PUSCH transmission scheme information contains data layer split and duplicate information, and precoders used for antenna groups.

### TECHNICAL FIELD

The present disclosure relates to wireless communications, and more specifically to full power uplink transmission.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

PUSCH transmission with 8 antenna ports (8TX PUSCH) is supported in NR Release 18 for advanced UE equipped with 8 antenna ports with one or multiple layers. This disclosure targets 8TX UE full power uplink transmission.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The present disclosure relates to methods, apparatuses, and systems that support full power uplink transmission.

Some implementations of the method and apparatuses described herein may further include a user equipment (UE) for wireless communication, comprising: at least one memory; and at least one processor coupled with the at least one memory and configured to cause the UE to: receive a DCI format 0_1 or 0_2 including a TPMI field, where the TPMI field contains PUSCH transmission scheme information, wherein, the PUSCH transmission scheme information contains data layer split and duplicate information, and precoders used for antenna groups.

In some implementations of the method and apparatuses described herein, the data layer split and duplicate information indicates that all antenna groups are used for transmission by duplicating data layer(s) transmitted in one antenna group to be transmitted in at least one of the other antenna groups. In one embodiment, all antenna groups transmitting the same set of data layers use a same precoder. In another embodiment, each of the antenna groups transmitting the same set of data layers use a different precoder. In some embodiment, the duplicated data layers include all or a subset of the data layers transmitted in the one antenna group. In some embodiment, if there are 2 antenna groups, both antenna groups transmit the same data layer(s). In some other embodiment, if there are 4 antenna groups, at least two antenna groups transmit the same data layer(s), and the other antenna group(s) transmit data layer(s) different from the data layer(s) transmitted by the at least two antenna groups.

In some implementations of the method and apparatuses described herein, the data layer split and duplicate information and the precoders used for antenna groups are tabulated in a table, and the PUSCH transmission scheme information is an index of the entry in the table. In some embodiment, each index is one of TPMIs for normal transmission or TPMIs for full power transmission. In some embodiment, the TPMIs for full power transmission by transmitting a duplicate of data layer(s) transmitted in one antenna group in at least one of the other antenna groups are received if the UE is configured with “UL full power transmission”=fullpowerMode1. In some embodiment, the at least one processor is further configured to cause the UE to: report a capability of supporting fullpowerMode1 for “UL full power transmission”.

Some implementations of the method and apparatuses described herein may include a processor in a UE for wireless communication, comprising: at least one controller coupled with at least one memory and configured to cause the processor to: receive a DCI format 0_1 or 0_2 including a TPMI field, where the TPMI field contains PUSCH transmission scheme information, wherein, the PUSCH transmission scheme information contains data layer split and duplicate information, and precoders used for antenna groups.

Some implementations of the method and apparatuses described herein may include a method performed by a user equipment (UE), the method comprising: receiving a DCI format 0_1 or 0_2 including a TPMI field, where the TPMI field contains PUSCH transmission scheme information, wherein, the PUSCH transmission scheme information contains data layer split and duplicate information, and precoders used for antenna groups.

Some implementations of the method and apparatuses described herein may include at least one memory; and at least one processor coupled with the at least one memory and configured to cause the base station to: transmit a DCI format 0_1 or 0_2 including a TPMI field, where the TPMI field contains PUSCH transmission scheme information, wherein, the PUSCH transmission scheme information contains data layer split and duplicate information, and precoders used for antenna groups.

### BRIEF DESCRIPTION OF THE DRAWINGS

FIG. 1 illustrates an example of a wireless communications system in accordance with aspects of the present disclosure.

FIG. 2 illustrates an example of a user equipment (UE) 200 in accordance with aspects of the present disclosure.

FIG. 3 illustrates an example of a processor 300 in accordance with aspects of the present disclosure.

FIG. 4 illustrates an example of a network equipment (NE) 400 in accordance with aspects of the present disclosure.

FIG. 5 illustrates antenna layouts with different number of antenna groups.

FIG. 6 illustrates a flowchart of method performed by a UE in accordance with aspects of the present disclosure.

FIG. 7 illustrates a flowchart of method performed by a NE in accordance with aspects of the present disclosure.

### DETAILED DESCRIPTION

Aspects of the present disclosure are described in the context of a wireless communications system.

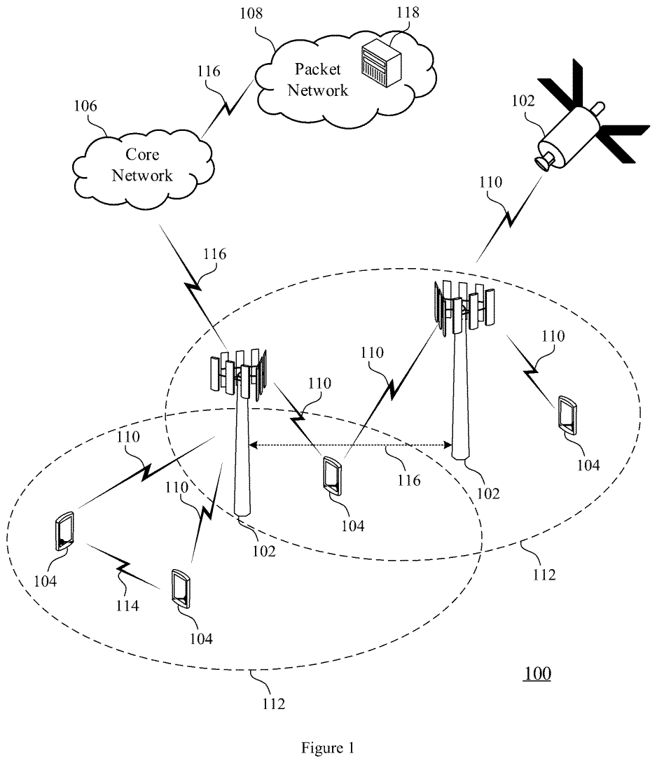

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE (Long Term Evoluation) network or an LTE-Advanced (LTE-A) network. In some other implementations, the wireless communications system 100 may be a New Radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link 110, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas 112 associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links 116 (e.g., S1, N2, N2, or network interface). The network entities 102 may communicate with each other over the backhaul links 116 (e.g., via an X2, Xn, or another network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network 108 over one or more backhaul links (e.g., via an S1, N2, N2, or another network interface). The packet data network 108 may include an application server 118. In some implementations, one or more UEs 104 may communicate with the application server 118. A UE 104 may establish a session (e.g., a protocol data unit (PDU) session, or the like) with the CN 106 via an NE 102. The CN 106 may route traffic (e.g., control information, data, and the like) between the UE 104 and the application server 118 using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHZ), FR4a or FR4-1 (52.6 GHZ-71 GHz), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

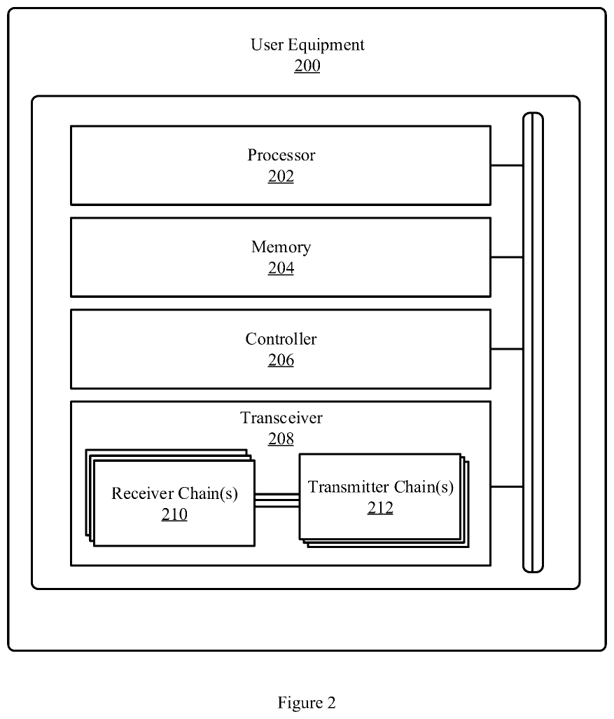

FIG. 2 illustrates an example of a UE 200 in accordance with aspects of the present disclosure. The UE 200 may include a processor 202, a memory 204, a controller 206, and a transceiver 208. The processor 202, the memory 204, the controller 206, or the transceiver 208, or various combinations thereof or various components thereof may be examples of means for performing various aspects of the present disclosure as described herein. These components may be coupled (e.g., operatively, communicatively, functionally, electronically, electrically) via one or more interfaces.

The processor 202, the memory 204, the controller 206, or the transceiver 208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 202 may include an intelligent hardware device (e.g., a general-purpose processor, a DSP, a CPU, an ASIC, an FPGA, or any combination thereof). In some implementations, the processor 202 may be configured to operate the memory 204. In some other implementations, the memory 204 may be integrated into the processor 202. The processor 202 may be configured to execute computer-readable instructions stored in the memory 204 to cause the UE 200 to perform various functions of the present disclosure.

The memory 204 may include volatile or non-volatile memory. The memory 204 may store computer-readable, computer-executable code including instructions when executed by the processor 202 cause the UE 200 to perform various functions described herein. The code may be stored in a non-transitory computer-readable medium such the memory 204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 202 and the memory 204 coupled with the processor 202 may be configured to cause the UE 200 to perform one or more of the functions described herein (e.g., executing, by the processor 202, instructions stored in the memory 204). For example, the processor 202 may support wireless communication at the UE 200 in accordance with examples as disclosed herein. The UE 200 may be configured to support a means for determining that a Physical Uplink Shared Channel (PUSCH) transmission is associated with a plurality of Phase-Tracking Reference Signal (PTRS) ports; and transmitting the PUSCH transmission together with the plurality of PTRS ports.

The controller 206 may manage input and output signals for the UE 200. The controller 206 may also manage peripherals not integrated into the UE 200. In some implementations, the controller 206 may utilize an operating system such as iOS®, ANDROID®, WINDOWS®, or other operating systems. In some implementations, the controller 206 may be implemented as part of the processor 202.

In some implementations, the UE 200 may include at least one transceiver 208. In some other implementations, the UE 200 may have more than one transceiver 208. The transceiver 208 may represent a wireless transceiver. The transceiver 208 may include one or more receiver chains 210, one or more transmitter chains 212, or a combination thereof.

A receiver chain 210 may be configured to receive signals (e.g., control information, data, packets) over a wireless medium. For example, the receiver chain 210 may include one or more antennas for receive the signal over the air or wireless medium. The receiver chain 210 may include at least one amplifier (e.g., a low-noise amplifier (LNA)) configured to amplify the received signal. The receiver chain 210 may include at least one demodulator configured to demodulate the receive signal and obtain the transmitted data by reversing the modulation technique applied during transmission of the signal. The receiver chain 210 may include at least one decoder for decoding the processing the demodulated signal to receive the transmitted data.

A transmitter chain 212 may be configured to generate and transmit signals (e.g., control information, data, packets). The transmitter chain 212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 212 may also include at least one power amplifier configured to amplify the modulated signal to an appropriate power level suitable for transmission over the wireless medium. The transmitter chain 212 may also include one or more antennas for transmitting the amplified signal into the air or wireless medium.

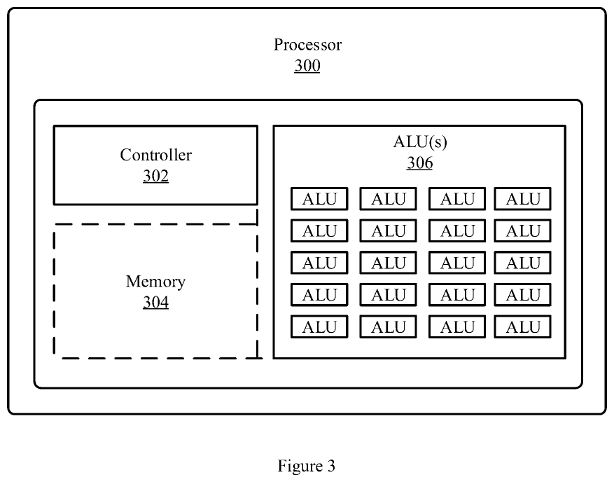

FIG. 3 illustrates an example of a processor 300 in accordance with aspects of the present disclosure. The processor 300 may be an example of a processor configured to perform various operations in accordance with examples as described herein. The processor 300 may include a controller 302 configured to perform various operations in accordance with examples as described herein. The processor 300 may optionally include at least one memory 304, which may be, for example, an L1/L2/L3 cache. Additionally, or alternatively, the processor 300 may optionally include one or more arithmetic-logic units (ALUs) 306. One or more of these components may be in electronic communication or otherwise coupled (e.g., operatively, communicatively, functionally, electronically, electrically) via one or more interfaces (e.g., buses).

The processor 300 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 300) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 302 may be configured to manage and coordinate various operations (e.g., signaling, receiving, obtaining, retrieving, transmitting, outputting, forwarding, storing, determining, identifying, accessing, writing, reading) of the processor 300 to cause the processor 300 to support various operations in accordance with examples as described herein. For example, the controller 302 may operate as a control unit of the processor 300, generating control signals that manage the operation of various components of the processor 300. These control signals include enabling or disabling functional units, selecting data paths, initiating memory access, and coordinating timing of operations.

The controller 302 may be configured to fetch (e.g., obtain, retrieve, receive) instructions from the memory 304 and determine subsequent instruction(s) to be executed to cause the processor 300 to support various operations in accordance with examples as described herein. The controller 302 may be configured to track memory address of instructions associated with the memory 304. The controller 302 may be configured to decode instructions to determine the operation to be performed and the operands involved. For example, the controller 302 may be configured to interpret the instruction and determine control signals to be output to other components of the processor 300 to cause the processor 300 to support various operations in accordance with examples as described herein. Additionally, or alternatively, the controller 302 may be configured to manage flow of data within the processor 300. The controller 302 may be configured to control transfer of data between registers, arithmetic logic units (ALUs), and other functional units of the processor 300.

The memory 304 may include one or more caches (e.g., memory local to or included in the processor 300 or other memory, such RAM, ROM, DRAM, SDRAM, SRAM, MRAM, flash memory, etc. In some implementations, the memory 304 may reside within or on a processor chipset (e.g., local to the processor 300). In some other implementations, the memory 304 may reside external to the processor chipset (e.g., remote to the processor 300).

The memory 304 may store computer-readable, computer-executable code including instructions that, when executed by the processor 300, cause the processor 300 to perform various functions described herein. The code may be stored in a non-transitory computer-readable medium such as system memory or another type of memory. The controller 302 and/or the processor 300 may be configured to execute computer-readable instructions stored in the memory 304 to cause the processor 300 to perform various functions. For example, the processor 300 and/or the controller 302 may be coupled with or to the memory 304, the processor 300, the controller 302, and the memory 304 may be configured to perform various functions described herein. In some examples, the processor 300 may include multiple processors and the memory 304 may include multiple memories. One or more of the multiple processors may be coupled with one or more of the multiple memories, which may, individually or collectively, be configured to perform various functions herein.

The one or more ALUs 306 may be configured to support various operations in accordance with examples as described herein. In some implementations, the one or more ALUs 306 may reside within or on a processor chipset (e.g., the processor 300). In some other implementations, the one or more ALUs 306 may reside external to the processor chipset (e.g., the processor 300). One or more ALUs 306 may perform one or more computations such as addition, subtraction, multiplication, and division on data. For example, one or more ALUs 306 may receive input operands and an operation code, which determines an operation to be executed. One or more ALUs 306 be configured with a variety of logical and arithmetic circuits, including adders, subtractors, shifters, and logic gates, to process and manipulate the data according to the operation. Additionally, or alternatively, the one or more ALUs 306 may support logical operations such as AND, OR, exclusive-OR (XOR), not-OR (NOR), and not-AND (NAND), enabling the one or more ALUs 306 to handle conditional operations, comparisons, and bitwise operations.

The processor 300 may support wireless communication in accordance with examples as disclosed herein. The processor 300 may be configured to or operable to support a means for determining that a Physical Uplink Shared Channel (PUSCH) transmission is associated with a plurality of Phase-Tracking Reference Signal (PTRS) ports; and transmitting the PUSCH transmission together with the plurality of PTRS ports.

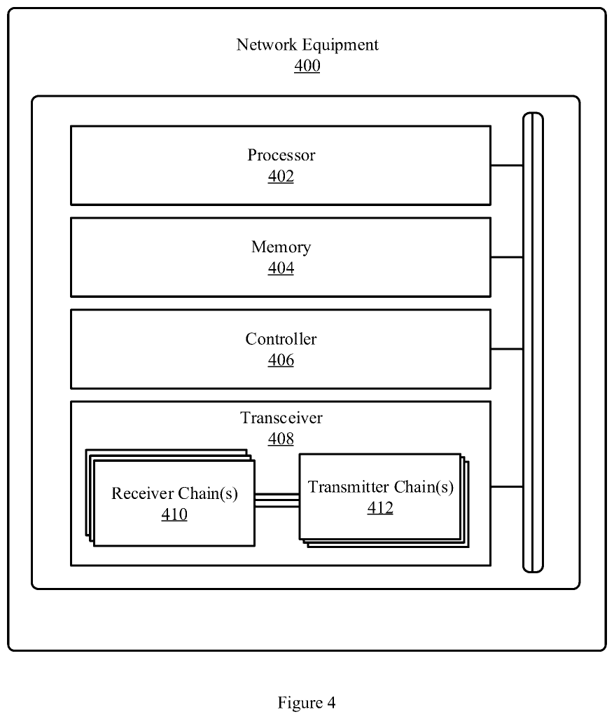

FIG. 4 illustrates an example of a NE 400 in accordance with aspects of the present disclosure. The NE 400 may include a processor 402, a memory 404, a controller 406, and a transceiver 408. The processor 402, the memory 404, the controller 406, or the transceiver 408, or various combinations thereof or various components thereof may be examples of means for performing various aspects of the present disclosure as described herein. These components may be coupled (e.g., operatively, communicatively, functionally, electronically, electrically) via one or more interfaces.

The processor 402, the memory 404, the controller 406, or the transceiver 408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 402 may include an intelligent hardware device (e.g., a general-purpose processor, a DSP, a CPU, an ASIC, an FPGA, or any combination thereof). In some implementations, the processor 402 may be configured to operate the memory 404. In some other implementations, the memory 404 may be integrated into the processor 402. The processor 402 may be configured to execute computer-readable instructions stored in the memory 404 to cause the NE 400 to perform various functions of the present disclosure.

The memory 404 may include volatile or non-volatile memory. The memory 404 may store computer-readable, computer-executable code including instructions when executed by the processor 402 cause the NE 400 to perform various functions described herein. The code may be stored in a non-transitory computer-readable medium such the memory 404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 402 and the memory 404 coupled with the processor 402 may be configured to cause the NE 400 to perform one or more of the functions described herein (e.g., executing, by the processor 402, instructions stored in the memory 404). For example, the processor 402 may support wireless communication at the NE 400 in accordance with examples as disclosed herein. The NE 400 may be configured to support a means for determining that a Physical Uplink Shared Channel (PUSCH) transmission is associated with a plurality of Phase-Tracking Reference Signal (PTRS) ports; and receiving the PUSCH transmission together with the plurality of PTRS ports.

The controller 406 may manage input and output signals for the NE 400. The controller 406 may also manage peripherals not integrated into the NE 400. In some implementations, the controller 406 may utilize an operating system such as iOS®, ANDROID®, WINDOWS®, or other operating systems. In some implementations, the controller 406 may be implemented as part of the processor 402.

In some implementations, the NE 400 may include at least one transceiver 408. In some other implementations, the NE 400 may have more than one transceiver 408. The transceiver 408 may represent a wireless transceiver. The transceiver 408 may include one or more receiver chains 410, one or more transmitter chains 412, or a combination thereof.

A receiver chain 410 may be configured to receive signals (e.g., control information, data, packets) over a wireless medium. For example, the receiver chain 410 may include one or more antennas for receive the signal over the air or wireless medium. The receiver chain 410 may include at least one amplifier (e.g., a low-noise amplifier (LNA)) configured to amplify the received signal. The receiver chain 410 may include at least one demodulator configured to demodulate the receive signal and obtain the transmitted data by reversing the modulation technique applied during transmission of the signal. The receiver chain 410 may include at least one decoder for decoding the processing the demodulated signal to receive the transmitted data.

A transmitter chain 412 may be configured to generate and transmit signals (e.g., control information, data, packets). The transmitter chain 412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 412 may also include at least one power amplifier configured to amplify the modulated signal to an appropriate power level suitable for transmission over the wireless medium. The transmitter chain 412 may also include one or more antennas for transmitting the amplified signal into the air or wireless medium.

The UE can be configured in two different modes for PUSCH multi-antenna precoding, referred as codebook (CB) based transmission and non-codebook (nCB) based transmission, respectively. When the UE is configured with codebook based PUSCH transmission, one SRS resource set used for codebook can be configured in a BWP of a cell for the UE. When the UE is configured with non-codebook based PUSCH transmission, one SRS resource set used for non-codebook can be configured in a BWP of a cell for the UE.

To enable codebook based PUSCH transmission, the UE shall be configured to transmit one or more SRS resources used for codebook for uplink channel measurement. Based on the measurements on the configured SRS resources transmitted by the UE, the gNB determines a suitable transmission rank (which may be abbreviated as “rank” hereinafter) and the precoding matrix from a pre-defined codebook, which includes a set of precoding matrices with different ranks, and sends the information to the UE when scheduling a PUSCH transmission.

When a UE is equipped with 8 antenna ports (e.g., PUSCH or SRS antenna ports), the base unit (e.g., gNB) may send to the UE a DCI (e.g., DCI with format 0_1 or DCI with format 0_2) scheduling dynamically scheduled PUSCH or type 2 configured-grant PUSCH with up to 8 layers (i.e., PUSCH layers) or a RRC message (e.g., configuredGrantConfig) to configure type 1 configured-grant PUSCH with up to 8 layers. The 8 antenna ports (e.g., PUSCH or SRS antenna ports) may be numbered as PUSCH or SRS antenna ports 1000, 1001, 1002, 1003, 1004, 1005, 1006, and 1007. Incidentally, a brief summary of CG PUSCH is as follows. CG (configured grant) PUSCH is used for semi-static UL traffic, which can be transmitted without dedicated scheduling DCI. Two types of CG PUSCH are specified in NR Release 15. For type 1 CG PUSCH, all the information used for the PUSCH transmission are configured by RRC signaling and the CG PUSCH can be periodically transmitted according to the configured period. For type 2 CG PUSCH, part of information used for the PUSCH transmission is configured by RRC signaling, while the other information is indicated by an activation DCI. Type 2 CG PUSCH can only be periodically transmitted upon receiving the activation DCI. When the UE receives a deactivation DCI to deactivate type 2 CG PUSCH, the corresponding PUSCH shall not be transmitted. Both type 1 CG PUSCH and type 2 CG PUSCH are configured by configured grant PUSCH configuration (i.e., by higher layer parameter configuredGrantConfig IE) and each configuredGrantConfig has an ID.

When the PUSCH layers are transmitted from the UE, a precoding matrix is used to perform UL precoding on modulated data in codebook based PUSCH transmission. The UE shall perform UL precoding according to Equation 1.

$$[ \begin{matrix}{z}_{0}^{( {P}_{0} )} ( i ) \\ ⋮ \\ {z}_{0}^{( {P}_{ρ - 1} )} ( i )\end{matrix} ] = {W}_{0} [ \begin{matrix}{y}_{0}^{( 0 )} ( i ) \\ ⋮ \\ {y}_{0}^{( {v}_{0} - 1 )} ( i )\end{matrix} ] \qquad Equation 1$$

where, the block of vector

$${[ {y}_{0}^{( 0 )} ( i ) … {y}_{0}^{( {v}_{0} - 1 )} ( i ) ]}^{T}$$

is the modulated data that will be transmitted; W₀ is the precoding matrix applied to the block of vector; and the block of vector

$${[ {z}_{0}^{( {P}_{0} )} ( i ) … {z}_{0}^{( {P}_{ρ - 1} )} ( i ) ]}^{T}$$

is the pre-coded data to be transmitted by the UE. v₀ indicates the number of PUSCH layers or the rank of the PUSCH. P₀ corresponds to PUSCH antenna port 1000 and β_{ρ-1} corresponds to PUSCH antenna port 1000+ρ−1. In this invention, ρ=8.

Coherent transmission is described as follows.

If a UE reports a capability of full-coherent and 8 antenna ports (i.e., PUSCH antenna port 1000, 1001, 1002, 1003, 1004, 1005, 1006 and 1007), all 8 PUSCH antenna ports can be used for coherent transmission of a PUSCH layer. For example, the precoding vector used for each layer can have 8 non-zero elements, e.g.,

$$W = {\frac{- 1}{2 \sqrt{2}} [ 1 , j , 1 , j , 1 , j , 1 , j ]}^{T}$$

is a valid precoding vector for a rank 1 PUSCH transmission with 8 full coherent antenna ports. If the phase difference between any two antenna ports among multiple antenna ports is fixed, the multiple antenna ports are coherent. If the phase difference between any two antenna ports among multiple antenna ports is not fixed, the multiple antenna ports are non-coherent.

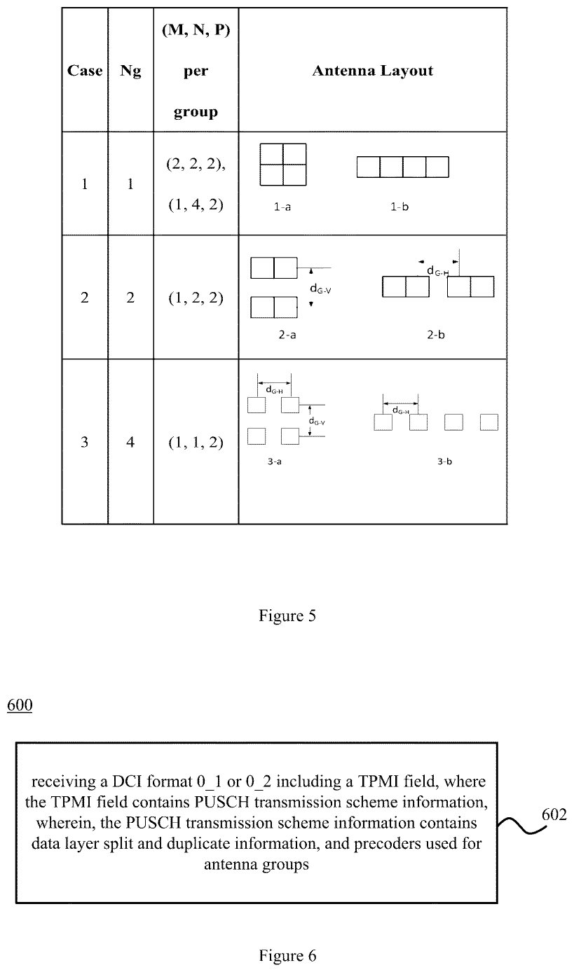

If a UE reports capability of partial-coherent or non-coherent with 8 antenna ports (i.e., PUSCH antenna port 1000, 1001, 1002, 1003, 1004, 1005, 1006 and 1007), coherent antenna ports (where the coherent antenna ports are a part of the 8 antenna ports) can be used for transmission of one PUSCH layer. This disclosure will discuss whether non-coherent antenna ports can be used for transmission of one PUSCH layer for partial-coherent UE. In particular, all 8 antenna ports are grouped as Ng antenna groups. All antenna ports within each antenna group are coherent, while antenna ports from different antenna groups are non-coherent. Several antenna layouts with different number of antenna groups are illustrated in FIG. 5.

In FIG. 5, Ng denotes the number of antenna groups. M denotes the number of antennas in vertical in an antenna group. N denotes the number of antennas in horizontal in an antenna group. P denotes the number of polarizations of each antenna. Each polarization of an antenna corresponds to an antenna port.

Antenna layout 1-a and antenna layout 1-b correspond to full coherent antenna array, i.e., all 8 antenna ports within each of antenna layout 1-a and antenna layout 1-b belong to one antenna group (e.g., antenna group #0, denoted as nNg=0) and are coherent antenna ports.

Antenna layout 2-a and antenna layout 2-b correspond to partial coherent antenna array with two antenna groups (Ng=2). For example, in each of antenna layout 2-a and antenna layout 2-b, each of antenna group #0 (a first antenna group, denoted as nNg=0) and antenna group #1 (a second antenna group, denoted as nNg=1) includes four coherent antenna ports.

Antenna layout 3-a and antenna layout 3-b correspond to partial coherent antenna array with four antenna groups (Ng=4). For example, in each of antenna layout 3-a and antenna layout 3-b, each of antenna group #0 (a first antenna group, denoted as nNg=0), antenna group #1 (a second antenna group, denoted as nNg=1), antenna group #2 (a third antenna group, denoted as nNg=2), and antenna group #3 (a fourth antenna group, denoted as nNg=3) includes two coherent antenna ports.

Before discussing the codebook design, the UE needs to report its antenna layout including the number of antenna groups 1≤Ng≤4, and optionally the antennas within each antenna group (M, N, P), where M indicates the number of antennas in horizontal, N indicates the number of antennas in vertical, P indicates the number of polarizations of each antenna. One polarization of each antenna corresponds to an antenna port. Each antenna group has the same antenna structure.

The UE can report the supported maxRank∈{1, 2, 3, 4, 5, 6, 7, 8}, i.e., the maximum number of PUSCH layers for a PUSCH transmission.

The gNB sends a DCI to the UE to schedule one or more PUSCH transmissions. The rank of the scheduled PUSCH transmission may be 1, 2, 3, 4, 5, 6, 7 or 8 depending on the reported maxRank. It means that the PUSCH transmission has L PUSCH layers, where L is equal to the rank, which is equal to or less than maxRank. A precoding matrix (which can also be referred to as precoder) shall be determined for the scheduled PUSCH transmission.

Incidentally, the number of columns of the precoding matrix indicates the number of layers of a PUSCH transmission for which the precoding matrix can be applied. So, precoding matrix (i.e., precoder) can be further described as rank R precoding matrix (precoder), e.g., rank 1 precoder, rank 2 precoder, rank 3 precoder, rank 4 precoder, rank 5 precoder, rank 6 precoder, rank 7 precoder, rank 8 precoder. Rank R precoding matrix (precoder) can be also denoted as R-layer precoding matrix (precoder), e.g., one-layer precoder (or single-layer precoder), two-layer precoder, three-layer precoder, four-layer precoder, five-layer precoder, six-layer precoder, seven-layer precoder, eight-layer precoder.

The number of rows of the precoding matrix (precoder) indicates the number of antenna ports for which the precoding matrix can be applied. For example, the precoding matrix (precoder) may have 2 or 4 or 8 rows (denoted as 2TX, 4TX, 8TX) for a UE with 2 antenna ports or 4 antenna ports or 8 antenna ports.

The maximal transmission powers of UEs are defined differently for different UE classes. In class 3 UE (Handheld UE), the maximal transmission power is 23 dBm. For a UE with 8 TX antenna ports, the maximal power of the power amplifier (PA) for each TX antenna port can be the same or different. UEs can be classified into three types of capabilities based on the PA power of the 8 antenna ports. For Capability 1 UE, each PA can transmit with the maximal power of 23 dBm. For Capability 2 UE, each PA can only transmit with ⅛ of the maximal power, so each PA is rated only at 14 dBm. For Capability 3 UE, some antenna ports can transmit with power higher than 14 dBm, while the rest transmit only with 14 dBm.

A full coherent UE transmits using the DFT-based type 1 codebook. This insures that the full coherent UE can always transmit with full power, because all 8 antenna ports always transmit together. Even for a Capability 2 UE, transmitting using 8 antenna ports ensures full power uplink transmission.

On the other hand, for a partial coherent 8TX UE (e.g., Ng=2 or Ng=4), all 8 antenna ports do not always transmit together. It means that, for a Capability 2 8TX UE (e.g., Ng=2 or Ng=4), full power uplink transmission may not be achieved with conventional agreed procoders.

This disclosure proposes solutions for full power uplink transmission for Capability 2 8TX UE. For a Capability 2 8TX UE, because all the antenna ports have PAS with only ⅛ (−9 dB) of the full power, all 8 antenna ports must transmit to reach full power. This requires additional precoders (TPMIs) in addition to the agreed set of precoders.

A first embodiment relates to partial coherent 8TX UE with Ng=2.

A partial coherent 8TX UE with Ng-2 has 2 coherent groups, where each of the 2 coherent groups includes four coherent antenna ports.

The current agreement on regular transmission mode (which can be also referred to as normal transmission mode and abbreviated as normal mode) defines a precoding structure as follows: these precoders have a two stage hierarchical structure, although the final table of TPMI may incorporate all the entries into a single table.

In a first stage, for rank N (where N is from 1 to 8) transmission, the N data layer(s) (where “data layer” may be abbreviated as “layer” hereinafter) are split between the two antenna groups, where N₁ (0<=N₁<=N) layer(s) are transmitted from the first antenna group, and N₂ (0<=N₂<=N) layer(s) are transmitted from the second antenna group, and N₁+N₂=N. A same layer is transmitted only from one of the antenna groups. Each (N1, N2) can be referred to as a layer scheme. The agreed possible layer schemes (i.e., layer splits) are given in Table 1:

TABLE 1

| | All layers in | Layers split |
|---|---|---|
| | one Antenna | across 2 Antenna |
| Rank | Group | Groups |
| 1 | (1, 0), (0, 1) | — |
| 2 | (2, 0), (0, 2) | — |
| 2 | — | (1, 1) |
| 3 | (3, 0), (0, 3) | — |
| 3 | — | (1, 2), (2, 1) |
| 4 | (4, 0), (0, 4) | — |
| 4 | — | (2, 2) |
| 5 | — | [(2, 3), (3, 2)] |
| 6 | — | (3, 3) |
| 7 | — | [(3, 4), (4, 3)] |
| 8 | — | (4, 4) |

After the number of layers (N₁ or N₂) is determined in each coherent group, a full coherent precoder of 4TX from the R15 codebooks (selected from TS 38.211, Table 6.3.1.5-2, Table 6.3.1.5-3, Table 6.3.1.5-5, Table 6.3.1.5-6, Table 6.3.1.5-7 (they are shown in the Appendix) depending on the transmission rank and waveform) is chosen for the antenna group.

Structurally, the transmission scheme (which includes the layer scheme and the precoder used for each antenna group) can be viewed as a (N₁, TPMI₁, N₂, TPMI₂), where Nᵢ and TPMIᵢ (where i is 1 or 2) are the number of layers (transmission rank) and 4TX codeword for antenna group i. The transmitted signal z of length 8 from the 8 antenna ports is given by

$$z = \frac{1}{\sqrt{2}} [ \begin{matrix}{W}_{1} & 0 \\ 0 & {W}_{2}\end{matrix} ] [ \begin{matrix}{s}_{1} \\ {s}_{2}\end{matrix} ] = \frac{1}{\sqrt{2}} [ \begin{matrix}{W}_{1} \\ 0\end{matrix} ] {s}_{1} + \frac{1}{\sqrt{2}} [ \begin{matrix}0 \\ {W}_{2}\end{matrix} ] {s}_{2} = \frac{1}{\sqrt{2}} [ \begin{matrix}{W}_{1} {s}_{1} \\ {W}_{2} {s}_{2}\end{matrix} ] ,$$

where W₁, W₂ are the precoders indicated by TPMI₁ and TPMI₂, and s₁ and s₂ are modulation symbol vector of length N₁ and N₂. Here 0 is the all-0 matrix of corresponding size. In particular, the “0” under W₁ has the same number of columns as W₁ and has 4 rows; and the “0” above W₂ has the same number of columns as W₂ and has 4 rows. Together N₁+N₂=N layers of modulation symbols are transmitted from both antenna groups (8 antenna ports). The scaling factor

$$\frac{1}{\sqrt{2}}$$

is introduced for normalization when the 4TX full-coherent precoders are used as W₁, W₂. If either Ny or N2 is 0, the corresponding W₁ or W₂ is zero, and nothing is transmitted from the corresponding antenna group. As a result, if N₂ is 0,

$$\frac{1}{\sqrt{2}} {W}_{s} {s}_{1}$$

is transmitted by the first antenna group; and if N₁ is 0,

$$\frac{1}{\sqrt{2}} {W}_{2} {s}_{2}$$

is transmitted by the second antenna group.

It can be seen that for rank 1-4, some layer splits use only a single antenna group to send all the layers, such as (1,0), (0,1), (2,0), (0,2), (3,0), (0,3), (4,0), (0,4). Since only 4 antenna ports in an antenna group are used for transmission, the maximal transmission power can only reach half of the full power. Incidentally, each of the other layer splits ((1,1), (1,2), (2,1), (2,2), [(2,3), (3,2)], (3,3), [(3,4), (4,3)] and (4,4)) uses both antenna groups for transmission, so they can naturally reach full power with all 8 antenna ports.

A first sub-embodiment of the first embodiment proposes to transmit the same N layers, from both the first and the second antenna groups by using the same precoder (i.e., TPMI₁=TPMI₂) for the layer splits that use only a single antenna group to transmit all the layers, such as (1,0), (0,1), (2,0), (0,2), (3,0), (0,3), (4,0), (0,4).

For 8TX UE where the first and second antenna groups are placed in a same plane side-by-side, it is better to use the same precoder (i.e., TPMI₁=TPMI₂) to transmit the N layers from both the first and second antenna groups. This is because the first and second antenna groups, although not coherent, function like two antenna panels. The channel between the first antenna group and a receiver (e.g., TRP) and the channel between the second antenna group and the same receiver (e.g., the same TRP) are very similar, and different only by a phase shift. This makes it possible to select one 4TX precoder that works for both of them.

Accordingly, the signal from the first antenna group and the signal from the second antenna group will arrive at the receiver with a random phase offset. The combined signal is received at the receiver, leading to non-coherent combining with 3 dB power gain over a single panel transmission. Because both the number of layers and the precoders are the same for the first and second antenna groups, the TPMI indication is simply (N, TPMI₁, N, TPMI₁). We use the letter N with double underlines (i.e., N) to represent that the N layer(s) transmitted from the second antenna group is the same N layer(s) from the first antenna group. The transmitted signal z from the 8 antenna ports of the two groups is given by

$$z = \frac{1}{\sqrt{2}} [ \begin{matrix}{W}_{1} \\ {W}_{1}\end{matrix} ] [ {s}_{1} ] = \frac{1}{\sqrt{2}} [ \begin{matrix}{W}_{1} {s}_{1} \\ {W}_{1} {s}_{1}\end{matrix} ] ,$$

where W₁ is the precoder indicated by TPMI₁, and s₁ is modulation symbol vector of length N.

For example, if N=1 and the TPMI₁ indicates the precoder

$${W}_{1} = \frac{1}{2} [ \begin{matrix}1 \\ - 1 \\ - j \\ j\end{matrix} ] ,$$

the transmitted signal is

$$z = \frac{1}{\sqrt{2}} [ \begin{matrix}1 \\ - 1 \\ - j \\ j \\ 1 \\ - 1 \\ - j \\ j\end{matrix} ]$$

and s₁ has length 1.

For another example, if N=2 and the TPMI₁ indicates the precoder

$${W}_{1} = \frac{1}{\sqrt{2}} [ \begin{matrix}1 & 1 \\ - 1 & - 1 \\ j & - j \\ - j & j\end{matrix} ] ,$$

the transmitted signal is

$$z = \frac{1}{4} [ \begin{matrix}1 & 1 \\ - 1 & - 1 \\ j & - j \\ - j & j \\ 1 & 1 \\ - 1 & - 1 \\ j & - j \\ - j & j\end{matrix} ] [ {s}_{1} ] .$$

and s₁ has length 2.

According to the first sub-embodiment, only N and TPMI₁ are required to be signaled to the UE. If the transmission rank N is embedded in TPMI₁ (It means that the transmission rank N is implied by TPMI₁), only TPMI₁ needs to be signaled to the UE. For example, TPMI₁ is selected from the set of 4TX codewords with ranks from 1 to 4. If TPMI₁ is selected from TPMIs 12-27 from Table 6.3.1.5-3, it is implied that N is 1; if TPMI₁ is selected from TPMIs 14-21 from Table 6.3.1.5-5, it is implied that N is 2; if TPMI₁ is selected from TPMIs 3-6 from Table 6.3.1.5-6, it is implied that N is 3; and if TPMI₁ is selected from TPMIs 3-4 from Table 6.3.1.5-7, it is implied that N is 4.

According to the first sub-embodiment, the layer allocations given in Table 1 can be enhanced to Table 2, in which a fourth column is added to indicate the new scheme of layer splits (i.e. layer split and duplicate) added for full power uplink transmission.

TABLE 2

| | All layers | Layers split | Layers split and |
|---|---|---|---|
| | in one | across 2 | duplicate for |
| | Antenna | Antenna | full power |
| Rank | Group | Groups | transmission |
| 1 | (1, 0), (0, 1) | — | (1, 1) |
| 2 | (2, 0), (0, 2) | — | (2, 2) |
| 2 | — | (1, 1) | |
| 3 | (3, 0), (0, 3) | — | (3, 3) |
| 3 | — | (1, 2), (2, 1) | |
| 4 | (4, 0), (0, 4) | — | (4, 4) |
| 4 | — | (2, 2) | |
| 5 | — | [(2, 3), (3, 2)] | |
| 6 | — | (3, 3) | |
| 7 | — | [(3, 4), (4, 3)] | |
| 8 | — | (4, 4) | |

If the all the layer split (N to N₁ and N₂), data layer duplicate ((N₁,0) or (0, N₂=N₁) to (N₁, N₁)) and precoders for the antenna groups are put into a single table, all these information will be aggregated and can be indicated by a single TPMI.

Using a full power TPMI does not mean that the UE necessarily transmits with full power. It is still subject to the normal rule of power control. The UE can transmit with full power when directed by the power control rule and using these full power TPMIs using all 8 antenna ports.

A second sub-embodiment of the first embodiment proposes to transmit the same N layers, from both the first and the second antenna groups by using different precoders (i.e., W₁ indicated by TPMI₁ is different from W₂ indicated by TPMI₂) for the layer splits that use only a single antenna group to transmit all the layers, such as (1,0), (0,1), (2,0), (0,2), (3,0), (0,3), (4,0), (0,4).

For 8TX UE where the first and second antenna groups are placed to face different directions, the channel between the first antenna group and a receiver (e.g., TRP) and the channel between the second antenna group and the same receiver (e.g., the same TRP) are uncorrelated. So, it is necessary to choose separate precoders W₁ and W₂ for the first and the second antenna groups.

According to the second sub-embodiment, the number of layers transmitted by the first and second antenna groups are the same, while the precoders are different for the first and second antenna groups. So, the TPMI indication is simply (N, TPMI₁, N, TPMI₂). The transmitted signal z from the 8 antenna ports of the two groups is given

$$z = \frac{1}{\sqrt{2}} [ \begin{matrix}{W}_{1} \\ {W}_{2}\end{matrix} ] [ {s}_{1} ] = \frac{1}{\sqrt{2}} [ \begin{matrix}{W}_{1} {s}_{1} \\ {W}_{2} {s}_{1}\end{matrix} ] ,$$

where W₁ is the precoder indicated by TPMI₁, W₂ is the precoder indicated by TPMI₂, and s₁ is modulation symbol vector of length N₁.

For example, for rank 1 transmission, if

$${W}_{1} = \frac{1}{2} [ \begin{matrix}1 \\ - 1 \\ - j \\ j\end{matrix} ] , {W}_{2} = \frac{1}{2} [ \begin{matrix}1 \\ 1 \\ 1 \\ 1\end{matrix} ] ,$$

then

$$z = \frac{1}{2 \sqrt{2}} [ \begin{matrix}1 \\ - 1 \\ - j \\ j \\ 1 \\ 1 \\ 1 \\ 1\end{matrix} ] [ {s}_{1} ] .$$

For another example, for rank 2 transmission, if

$${W}_{1} = \frac{1}{2 \sqrt{2}} [ \begin{matrix}1 & 1 \\ - 1 & - 1 \\ j & - j \\ - j & j\end{matrix} ] , {W}_{2} = \frac{1}{2 \sqrt{2}} [ \begin{matrix}1 & 1 \\ 1 & 1 \\ j & - j \\ j & - j\end{matrix} ] ,$$

then

$$z = \frac{1}{4} [ \begin{matrix}1 & 1 \\ - 1 & - 1 \\ j & - j \\ - j & j \\ 1 & 1 \\ 1 & 1 \\ j & - j \\ j & - j\end{matrix} ] [ {s}_{1} ] .$$

Each layer is transmitted using all 8 antenna ports with total power of ½.

According to the second sub-embodiment, only N, TPMI₁ and TPMI₂ are required to be signaled to the UE. If the transmission rank N is embedded in TPMI₁, only TPMI₁ and TPMI₂ need to be signaled to the UE. For example, TPMI₁ is selected from the set of 4TX codewords with ranks from 1 to 4. If TPMI₁ is selected from TPMIs 12-27 from Table 6.3.1.5-3, N is 1; if TPMI₁ is selected from TPMIs 14-21 from Table 6.3.1.5-5, N is 2; if TPMI₁ is selected from TPMIs 3-6 from Table 6.3.1.5-6, N is 3; and if TPMI₁ is selected from TPMIs 3-4 from Table 6.3.1.5-7, N is 4.

TPMI₂ only needs to be selected from a small set of precoders of the same rank. For example, if TPMI₁ is selected from TPMIs 12-27 from Table 6.3.1.5-3, TPMI₂ needs to be selected from TPMIs 12-27 from Table 6.3.1.5-3 except for TPMI₁; if TPMI₁ is selected from TPMIs 14-21 from Table 6.3.1.5-5, TPMI₂ needs to be selected from TPMIs 14-21 from Table 6.3.1.5-5 except for TPMI₁; if TPMI₁ is selected from TPMIs 3-6 from Table 6.3.1.5-6, TPMI₂ needs to be selected from TPMIs 3-6 from Table 6.3.1.5-6 except for TPMI₁; and if TPMI₁ is selected from TPMIs 3-4 from Table 6.3.1.5-7, TPMI₂ needs to be selected from TPMIs 3-4 from Table 6.3.1.5-7 except for TPMI₁. Since the TPMIs 12-27 from Table 6.3.1.5-3 is the size of the largest subset (with 16 states), only 4 bits or 16 states needs to be reserved for TPMI₂, in the DCI containing the indication of TPMI₂.

Signaling only TPMI1 (not TPMI1 and TPMI2 separately) implies there will be not be entries (N, TPMI₁, N′, TPMI₂) in the TPMI table where TPMI₁≠TPMI₂.

A third sub-embodiment of the first embodiment is a variety of the second sub-embodiment. As described in the second sub-embodiment, for 8TX UE where the first and second antenna groups are placed to face different directions, the channel between the first antenna group and a receiver (e.g., TRP) and the channel between the second antenna group and the same receiver (e.g., the same TRP) are uncorrelated. So, it is possible that the first antenna group and the second antenna group can transmit different ranks. That is, rank (W₁)≠rank (W₂), and max (rank (W₁), rank (W₂))=length (s₁).

That is, one of the first antenna group and the second antenna group transmit N layers, while the other of the first antenna group and the second antenna group transmit a subset of N layers (e.g., N′ (<N) layers). For example, N=rank (W₁)>rank (W₂)=N′. In this condition, the transmitted signal needs to be written as

$$z = \frac{1}{\sqrt{2}} [ \begin{matrix}{W}_{1} \\ \begin{matrix}{W}_{2} & 0\end{matrix}\end{matrix} ] [ {s}_{1} ] = \frac{1}{\sqrt{2}} [ \begin{matrix}{W}_{1} {s}_{1} \\ {W}_{2} {trun}_{{N}^{′}} ( {s}_{1} )\end{matrix} ] ,$$

where the function trun_{N}′(s₁) truncates the vector s₁ of length N into length N′ and only keeps the first N′ elements. Since N′>=1, N>=2. Because W₁ has N columns and W₂ has N′<N columns, the 0 matrix in the equation has the 4 rows and (N−N′) column(s). Consequently, the first N′ element(s) of s₁ is transmitted from all the 8 antenna ports, and the remaining N-N′ elements are transmitted only from the first 4 antenna ports in the first antenna group.

For example, if N=2 and N′=1, then

$${W}_{1} = \frac{1}{2 \sqrt{2}} [ \begin{matrix}1 & 1 \\ - 1 & - 1 \\ j & - j \\ - j & j\end{matrix} ] and {W}_{2} = \frac{1}{2} [ \begin{matrix}1 \\ 1 \\ 1 \\ 1\end{matrix} ] ,$$

$$z = \frac{1}{4} [ \begin{matrix}1 & 1 \\ - 1 & - 1 \\ j & - j \\ - j & j \\ \sqrt{2} & 0 \\ \sqrt{2} & 0 \\ \sqrt{2} & 0 \\ \sqrt{2} & 0\end{matrix} ] [ {s}_{1} ] .$$

The UE needs to know (N, TPMI₁, N′, TPMI₂). If the information Nis embedded in TPMI₁, N′ is embedded in TPMI₂, then only TPMI₁ and TPMI₂ need to be signaled to the UE in DCI.

For example, TPMI₁ is selected from the set of 4TX codewords with ranks from 2 to 4.

If TPMI, is selected from TPMIs 14-21 from Table 6.3.1.5-5, N is 2, and N′ is 1, TPMI₂ is selected from TPMIs 12-27 from Table 6.3.1.5-3.

If TPMI₁ is selected from TPMIs 3-6 from Table 6.3.1.5-6, N is 3, and N′ can be 1 or 2. If TPMI₂ is selected from TPMIs 12-27 from Table 6.3.1.5-3, N′ is 1. If TPMI₂ is selected from TPMIs 14-21 from Table 6.3.1.5-5, N′ is 2.

If TPMI₁ is selected from TPMIs 3-4 from Table 6.3.1.5-7, N is 4, and N′ can be 1 or 2 or 3. If TPMI₂ is selected from TPMIs 12-27 from Table 6.3.1.5-3. N′ is 1. If TPMI₂ is selected from TPMIs 14-21 from Table 6.3.1.5-5, N′ is 2. If TPMI₂ is selected from TPMIs 3-6 from Table 6.3.1.5-6, N′ is 3.

It is also possible that N=rank (W₂)>rank (W₁)=N′. It means that the transmitted signal needs to be written as

$$z = \frac{1}{2} [ \begin{matrix}\begin{matrix}{W}_{1} & 0\end{matrix} \\ {W}_{2}\end{matrix} ] [ {s}_{1} ] .$$

Consequently, the first N′ element(s) of s₁ is transmitted only from the first 4 antenna ports in the first antenna group, and the remaining N-N′ elements are transmitted from all the 8 antenna ports.

According to the third sub-embodiment, the layer allocations given in Table 2 can be further enhanced to Table 3, in which a fifth column is added to indicate the new schemes added for full power transmission when the first antenna group and the second antenna group can transmit different ranks. In Table 3, (N,N′) or (N′,N) means that N′ layer(s) are the first N′ layer(s) of the N layers.

TABLE 3

| | | | | Layers split |
|---|---|---|---|---|
| | | | Layers split | and duplicate |
| | All layers | Layers split | and duplicate | for full power |
| | in one | across 2 | for full | transmission |
| | Antenna | Antenna | power | with different |
| Rank | Group | Groups | transmission | ranks |
| 1 | (1, 0), (0, 1) | — | (1, 1) | |
| 2 | (2, 0), (0, 2) | — | (2, 2) | (2, 1) |
| | | | | (1, 2) |
| 2 | — | (1, 1) | | |
| 3 | (3, 0), (0, 3) | — | (3, 3) | (3, 2), (3, 1) |
| | | | | (2, 3), (1, 3) |
| 3 | — | (1, 2), (2, 1) | | |
| 4 | (4, 0), (0, 4) | — | (4, 4) | (4, 3), (4, 2), (4, 1), |
| | | | | (1, 4), (2, 4), (3, 4) |
| 4 | — | (2, 2) | | |
| 5 | — | [(2, 3), (3, 2)] | | |
| 6 | — | (3, 3) | | |
| 7 | — | [(3, 4), (4, 3)] | | |
| 8 | — | (4, 4) | | |

A second embodiment relates to partial coherent 8TX UE with Ng=4.

A partial coherent 8TX UE with Ng=4 has 4 coherent groups, where each of the 4 coherent groups includes two coherent antenna ports.

Similar to the first embodiment, full power can be reached only when all the antenna ports are used for transmission. In the agreed layer split schemes for partial coherent 8TX UE with Ng=4 as shown in Table 4, those schemes that utilize all 4 antenna groups (thus can reach full power) are marked in underline. All the other schemes cannot reach full power and need enhancement.

TABLE 4

| | All layers | Layers split across |
|---|---|---|
| | in one | 4 Antenna Groups |
| Rank | Antenna Group | (All possible permutations) |
| 1 | (1, 0, 0, 0), (0, 1, 0, 0), | |
| | (0, 0, 1, 0), (0, 0, 0, 1) | |
| 2 | (2, 0, 0, 0), (0, 2, 0, 0), | |
| | (0, 0, 2, 0), (0, 0, 0, 2) | |
| 2 | | Transmission by 2 of the |
| | | 4 antenna groups: |
| | | (1, 1, 0, 0), (1, 0, 1, 0), (1, 0, 0, 1) |
| | | (0, 1, 1, 0), (0, 1, 0, 1), (0, 0, 1, 1) |
| 3 | | Transmission by 2 of the |
| | | 4 antenna groups: |
| | | (2, 1, 0, 0), (2, 0, 1, 0), (2, 0, 0, 1), |
| | | (0, 2, 1, 0), (0, 2, 0, 1), (0, 0, 2, 1), |
| | | Transmission by 3 of the |
| | | 4 antenna groups: |
| | | (1, 1, 1, 0), (1, 1, 0, 1), |
| | | (1, 0, 1, 1), (0, 1, 1, 1) |
| 4 | | (1, 1, 1, 1) |
| 4 | | Transmission by 2 of the |
| | | 4 antenna groups: |
| | | (2, 2, 0, 0), (2, 0, 2, 0), (2, 0, 0, 2) |
| | | (0, 2, 2, 0), (0, 2, 0, 2), (0, 0, 2, 2) |
| 5 | | Transmission by 3 of the |
| | | antenna groups: |
| | | (2, 0, 2, 1), (0, 2, 2, 1), |
| | | Transmission by 4 of the |
| | | 4 antenna groups: |
| | | (1, 1, 2, 1) |
| 6 | | Transmission by 3 of the |
| | | 4 antenna groups: |
| | | (2, 2, 2, 0), (2, 0, 2, 2) |
| | | Transmission by 4 of the |
| | | 4 antenna groups: |
| | | (2, 1, 2, 1) |
| 7 | — | Transmission by 4 of the |
| | | 4 antenna groups: |
| | | (2, 1, 2, 2) |
| 8 | — | (2, 2, 2, 2) |

Similar to the first sub-embodiment of the first embodiment, duplicated layer transmission to those antenna groups that were previously unused is introduced in the second embodiment. It means that a same set of layer(s) can be transmitted in more than one antenna group, e.g., two or three or four antenna groups.

Table 4 is enhanced as Table 5, in which the third column is enhanced, and a fourth column, a fifth column and a sixth column are added.

TABLE 5

| | | Layers split | | | |
|---|---|---|---|---|---|
| | | across 4 | | Simplified | Transmission scheme |
| | All layers | Antenna | New layer | new layer | with TPMI (when the |
| | in one | Groups (All | split/ | split/ | same TPMI is reused |
| | Antenna | possible | duplicate | duplicate | for duplicated |
| Rank | Group | permutations) | schemes | schemes | transmission) |
| 1 | (1, 0, 0, 0), | | (1, 1, 1, 1) | (1, 1, 1, 1) | (1, TPMI₁, 1, TPMI₁, 1, |
| | (0, 1, 0, 0), | | | | TPMI₁, 1, TPMI₁) |
| | (0, 0, 1, 0), | | | | |
| | (0, 0, 0, 1) | | | | |
| 2 | (2, 0, 0, 0), | | (2, 2, 2, 2) | (2, 2, 2, 2) | (2, TPMI₁, 2, TPMI₁, 2, |
| | (0, 2, 0, 0), | | | | TPMI₁, 2, TPMI₁) |
| | (0, 0, 2, 0), | | | | |
| | (0, 0, 0, 2) | | | | |
| 2 | | Transmission | (1, 1′, 1, 1′), | (1, 1′, 1, 1′), | (1, TPMI₁, 1′, TPMI₂, 1, |
| | | by 2 of the | (1, 1, 1′, 1′), | [symbol] | TPMI₁, 1′, TPMI₂) |
| | | 4 antenna | (1, 1, 1′, 1′), | | |
| | | groups: | (1, 1, 1′, 1′), | | |
| | | (1, 1′, 0, 0), | (1, 1, 1′, 1′) | | |
| | | (1, 0, 1′, 0), | (1, 1′, 1, 1′) | | |
| | | (1, 0, 0, 1′) | | | |
| | | (0, 1, 1′, 0), | | | |
| | | (0, 1, 0, 1′), | | | |
| | | (0, 0, 1, 1′) | | | |
| 3 | | Transmission | (2, 1, 2, 1), | (2, 1, 2, 1), | (2, TPMI₁, 1, TPMI₂, 2, |
| | | by 2 of the | (2, 2, 1, 1), | [symbol] | TPMI₁, 1, TPMI₂) |
| | | 4 antenna | (2, 2, 1, 1), | | |
| | | groups: | (2, 2, 1, 1), | | |
| | | (2, 1, 0, 0), | (2, 2, 1, 1), | | |
| | | (2, 0, 1, 0), | (2, 1, 2, 1) | | |
| | | (2, 0, 0, 1), | | | |
| | | (0, 2, 1, 0), | | | |
| | | (0, 2, 0, 1), | | | |
| | | (0, 0, 2, 1), | | | |
| | | Transmission | (1, 1′, 1″, 1), | (1, 1′, 1″, 1) | (1, TPMI₁, 1′, TPMI₂, 1″, |
| | | by 3 of the | (1, 1′, 1, 1″), | | TPMI₃, 1, TPMI₁) |
| | | 4 antenna | (1, 1, 1′,1″), | | |
| | | groups: | (1, 1, 1′,1″) | | |
| | | (1, 1′, 1″, 0), | | | |
| | | (1, 1′, 0, 1″), | | | |
| | | (1, 0, 1′, 1″), | | | |
| | | (0, 1, 1′, 1″) | | | |
| 4 | | (1 ,1′, 1″, 1′″) | | | |
| 4 | | Transmission | (2, 2′, 2, 2′), | (2, 2′, 2, 2′), | (2, TPMI₁, 2′, TPMI₂, 2, |
| | | by 2 of the | (2, 2, 2′, 2′), | [symbol] | TPMI₁, 2′, TPMI₂) |
| | | 4 antenna | (2, 2, 2′, 2′), | | |
| | | groups: | (2, 2, 2′, 2′), | | |
| | | (2, 2′, 0, 0), | (2, 2, 2′, 2′), | | |
| | | (2, 0, 2′, 0), | (2, 2′, 2, 2′) | | |
| | | (2, 0, 0, 2′) | | | |
| | | (0, 2, 2′, 0), | | | |
| | | (0, 2, 0, 2′), | | | |
| | | (0, 0, 2, 2′) | | | |
| 5 | | Transmission | (2, 2, 2′, 1), | (2, 2, 2′, 1) | (2, TPMI₁, 2, TPMI₁, 2′, |
| | | by 3 of the | (2, 2, 2′, 1) | | TPMI₃, 1, TPMI₄) |
| | | antenna | | | |
| | | groups: | | | |
| | | (2, 0, 2′, 1), | | | |
| | | (0, 2, 2′, 1), | | | |
| | | Transmission | | | |
| | | by 4 of the | | | |
| | | 4 antenna | | | |
| | | groups: | | | |
| | | (1, 1′, 2, 1″) | | | |
| 6 | | Transmission | (2, 2′, 2″, 2), | (2, 2′, 2″, 2), | (2, TPMI₁, 2′, TPMI₂, 2″, |
| | | by 3 of the | (2, 2, 2′, 2″) | [symbol] | TPMI₃, 2, TPMI₁) |
| | | 4 antenna | | | |
| | | groups: | | | |
| | | (2, 2′, 2″, 0), | | | |
| | | (2, 0, 2′, 2″) | | | |
| | | Transmission | | | |
| | | by 4 of the | | | |
| | | 4 antenna | | | |
| | | groups: | | | |
| | | (2, 1, 2′, 1′) | | | |
| 7 | | Transmission | | | |
| | | by 4 of the | | | |
| | | 4 antenna | | | |
| | | groups: | | | |
| | | (2, 1, 2′, 2″) | | | |
| 8 | | (2, 2′, 2″, 2′″) | | | |

In the third column of Table 5, (1) is enhanced as (1), (1′), (1″) and (1′″) to represent different sets of one layer transmitted from different antenna groups; and (2) is enhanced as (2), (2′), (2″) and (2″″) to represent different sets of two layers transmitted from different antenna groups.

In addition, in the fourth, the fifth and the sixth columns, each of 1, 1′, 2 and 2′ with double underlines (i.e., 1, 1′, 2 and 2′) represent that this layer is a duplicate of one layer (for 1 and 1′) or two layers (for 2 and 2′) transmitted from the previously used antenna group and is transmitted from the other previously unused antenna group(s). For example, 1 represents a duplicate of one layer (1) transmitted from the previously used antenna group and is transmitted from the other previously unused antenna group.

For example, for rank 1, the normal scheme only selects one of the antenna groups for transmission, that is, ((1,0,0,0), (0,1,0,0), (0,0,1,0), (0,0,0,1)). In particular, (1,0,0,0) means that only the first antenna group is selected for transmission; (0,1,0,0) means that only the second antenna group is selected for transmission; (0,0,1,0) means that only the third antenna group is selected for transmission; and (0,0,0,1) means that only the fourth antenna group is selected for transmission.

In the new scheme, the one layer is duplicated to all other three antenna groups that are previously unused. That is, the one layer (i.e., represented by “1”) is transmitted by all four antenna groups, thus reaching full power. Incidentally, Table 4 only includes new scheme (1,1,1,1) which means that the one layer transmitted from the first antenna group is duplicated and transmitted from the second, the third and the fourth antenna groups, but does not include new scheme (1,1,1,1) (which means that the one layer transmitted from the second antenna group is duplicated and transmitted from the first, the third and the fourth antenna groups), (1,1,1,1) (which means that the one layer transmitted from the third antenna group is duplicated and transmitted from the first, the second and the fourth antenna groups), and (1,1,1,1) which means that the one layer transmitted from the fourth antenna group is duplicated and transmitted from the first, the second and the third antenna groups since they are substantially the same as (1,1,1,1) (that is, the same one layer is transmitted from all four antenna groups).

For rank 2, if only 1 antenna group is selected for transmission in normal mode, that is, ((2,0,0,0), (0,2,0,0), (0,0,2,0), (0,0,0,2)), the new scheme (i.e., (2,1,1,1)) similar to new scheme for rank 1 is included in Table 5, that is, all four antenna groups are used for transmission to reach full power.

For rank 2, if two layers are split and transmitted in two antenna groups in the normal mode, that is, ((1,1′,0,0), (1,0,1′,0), (1,0,0,1′), (0,1,1′,0), (0,1,0,1′), (0,0,1,1′)), the two layers are duplicated and transmitted by other two antenna groups that are previously unused, thus reaching full power. To make it simple, the first layer (1) is duplicated and transmitted in the first unused antenna group, and the second layer (1′) is duplicated and transmitted in the second unused antenna group. As shown in Table 5, (1,1′,1,1′), (1,1,1′,1′), (1,1,1′,1′), (1,1,1′,1′), (1,1,1′,1′), (1,1′,1,1′) are obtained. Among (1,1′,1,1′), (1,1,1′,1′), (1,1,1′,1′), (1,1,1′,1′), (1,1,1′,1′), (1,1′,1,1′), there are only two different transmissions (1,1′,1,1′), (1,1,1′,1′) (e.g., the first two). The other four (e.g., the last four of them, that is, (1,1,1′,1′), (1,1,1′,1′), (1,1,1′,1′), (1,1′,1,1′) that are in italic in Table 5) are the same transmissions as either (1,1′,1,1′) (i.e., the first one layer is transmitted from the first and the third antenna groups, and the second one layer is transmitted from the second and the fourth antenna groups) or (1,1,1′,1′) (i.e., the first one layer is transmitted from the first and the second antenna groups, and the second one layer is transmitted from the third and the fourth antenna groups).

If the four antenna groups are placed side by side, there will be little difference between (1,1′,1,1′) and (1,1,1′,1′). To further simplify the scheme, only (1,1′,1,1′) is maintained in the fifth column of Table 5 for rank 2 where two antenna groups are selected for transmission in normal mode. It can be seen that (1,1,1′,1′) is shown to further have a strikethrough, i.e., in the fifth column of Table 5.

The principle of the fourth column of Table 5 for other ranks (e.g., rank 3 (transmission by 2 or 3 of the antenna groups in normal mode), rank 4 (transmission by 2 of the antenna groups in normal mode), rank 5 (transmission by 3 of the antenna groups in normal mode) and rank 6 (transmission by 3 of the antenna groups in normal mode)) is the same as the above-described principle for rank 2 (transmission by 2 of the 4 antenna groups). That is, the first unused antenna group is used to transmit the duplicate of the layer(s) transmitted from the first used antenna group in the normal mode, and the second unused antenna group is used to transmit the duplicate of the layer(s) transmitted from the second used antenna group in the normal mode, etc, until all of the unused antenna groups are used to transmit.

The principle of the fifth column of Table 5 for other ranks is also the same as the above-described principle for rank 2 (transmission by 2 of the 4 antenna groups). The duplicated schemes are removed so that only one or two different schemes remain. In addition, if there are still two different schemes, only one of them is maintained while the other is shown to have a strikethrough.

In view of the above, detailed explanation of the other ranks for the fourth column and the fifth column is omitted.

The above schemes, i.e., layer(s) split in the second and third columns according to normal mode; layer(s) duplicate in the fourth column according to this disclosure; and layers simplification (which can be regarded as a special layer(s) duplicate) in the fifth column according to this disclosure, only indicate which layer(s) are transmitted and which transmitted layer(s) are transmitted once or multiple times from which antenna group(s). The precoding matrices used in each antenna group need to be determined.

For partial coherent 8TX UE with Ng=4, each of the precoders of each used antenna group is taken from the 2TX full coherent TPMIs. That is, TPMI 2-5 in Table 6.3.1.5-1 for 1 layer, and TPMI 2-3 in Table 6.3.1.5-4 for 2 layer transmission (see the Appendix). In addition, it was agreed that, in the normal mode, the TPMI of each used antenna group can be signaled independently.

Conceptually, the complete transmission scheme can be viewed as (N1, TPMI₁. N2, TPMI₂, N3, TPMI₃, N4, TPMI₄), where the i^{th} (i is from 1 to 4) antenna group uses the precoding matrix TPMI₁ to transmit Nᵢ layers. The newly added layer schemes introduce more signaling overhead, because more precoders in the previously unused antenna groups need to be determined and signalled.

To reduce the overhead, we can use the same precoder in those antenna groups where the same layers are transmitted. As an example, for the layer scheme (1,1,1,1) to transmit 1 layer with four antenna groups, its complete transmission scheme can be viewed as (1,TPMI₁,1, TPMI₁,1, TPMI₁,1, TPMI₁). It means that the precoder TPMI₁ can be signalled only once in DCI and used in all four antenna groups.

The sixth column of Table 5 includes the transmission scheme of each simplified layer scheme in the fifth column.

Similar to the second sub-embodiment of the first embodiment, if the antenna groups face different directions, it is necessary to use different precoders to suite their individual channels. In this case, four separate TPMIs will need to be signaled to the UE.

Similar to the third sub-embodiment of the first embodiment, it is only necessary to ensure that each antenna group is used to transmit, so that full power can be reached. It means that, if two layers are duplicated and transmitted from another antenna group in the layer scheme included in the fourth column, it is possible that only one of the two layers (e.g., a first layer of the two layers) is duplicated and transmitted from the other antenna group while the other layer of the two layers is not duplicated.

A third embodiment relates to signaling of the TPMI.

The base station (e.g., gNB) determines the layer scheme (split, duplication, simplification (special duplication)) and the precoders used for the antenna groups. For Ng=2, the information (N₁, TPMI₁, N₂, TPMI₂) is necessary; and for Ng=4, the information (N₁, TPMI₁, N₂, TPMI₂, N₃, TPMI₃, N₄, TPMI₄) is necessary. These information can be signaled as an aggregate TPMI, e.g., newly added TPMIs for full power uplink transmission. The newly added TPMIs for full power transmission can be tabulated together with the regular transmission TPMIs (which are either non-full power or naturally full power) in the same table. Accordingly, the index in the TPMI table can be sent to the UE in DCI format 0_1 or 0_2.

It is possible that only a subset of the above-described full power TPMIs will be standardized, or only a subset is mandatory and some others are optional and the rest are not standardized. For example, for Ng=2, it is possible that only (1, TPMI₁,1, TPMI₁) is mandatory, and (2, TPMI₁, 2′, TPMI₁), (3, TPMI₁, 3′, TPMI₁), (4, TPMI₁, 4′, TPMI₁) are optional. For another example, for Ng=4, it is possible that only (1,TPMI₁,1, TPMI₁,1, TPMI₁,1, TPMI₁), (2, TPMI₁,2, TPMI₁,2, TPMI₁,2, TPMI₁), (1,TPMI₁,1′, TPMI₂,1, TPMI₁,1′, TPMI₂), (2, TPMI₁,1, TPMI₂,2, TPMI₁,1, TPMI₂), (1, TPMI₁, 1′, TPMI₂,1″, TPMI₃,1, TPMI₁) are mandatory, and (2,TPMI₁,2′, TPMI₂,2, TPMI₁,2′, TPMI₂) is optional.

As a whole, only the standardized entries will be included in the TPMI table. If there be any optional TPMIs, they will be eligible for DCI indication when the RRC configuration message PUSCH-config configures the codebooksubset to include these entries (i.e., optional TPMIs).

The new TPMIs added according to this disclosure may be used only if the UE reports a capability of supporting fullpowerMode1 for “UL full power transmission” in UE capability set and the UE is configured with “UL full power transmission”=fullpowerMode1, e.g., in RRC signaling PUSCH-config.

Upon receiving the DCI, UE performs the layer split and duplicate based on the TPMI and transmit the PUSCH accordingly, i.e., transmitting the data layers of the PUSCH by using layer split and duplicate information and the precoder(s) indicated by the TPMI.

In some aspects, items as examples of the disclosure concerning UE or base station may be summarized as follows:

1. A user equipment (UE) for wireless communication, comprising:
at least one memory; and
at least one processor coupled with the at least one memory and configured to cause the UE to:
receive a DCI format 0_1 or 0_2 including a TPMI field, where the TPMI field contains PUSCH transmission scheme information, wherein
the PUSCH transmission scheme information contains data layer split and duplicate information, and precoders used for antenna groups.

2. The UE of item 1, wherein, the data layer split and duplicate information indicates that all antenna groups are used for transmission by duplicating data layer(s) transmitted in one antenna group to be transmitted in at least one of the other antenna groups.

3. The UE of item 2, wherein, all antenna groups transmitting the same set of data layers use a same precoder.

4. The UE of item 2, wherein, each of the antenna groups transmitting the same set of data layers use a different precoder.

5. The UE of item 2, wherein, the duplicated data layers include all or a subset of the data layers transmitted in the one antenna group.

6. The UE of item 2, wherein, if there are 2 antenna groups, both antenna groups transmit the same data layer(s).

7. The UE of item 2, wherein, if there are 4 antenna groups, at least two antenna groups transmit the same data layer(s), and the other antenna group(s) transmit data layer(s) different from the data layer(s) transmitted by the at least two antenna groups.

8. The UE of item 1, wherein, the data layer split and duplicate information and the precoders used for antenna groups are tabulated in a table, and the PUSCH transmission scheme information is an index of the entry in the table.

9. The UE of item 8, wherein, each index is one of TPMIs for normal transmission or TPMIs for full power transmission.

10. The UE of item 9, wherein, the TPMIs for full power transmission by transmitting a duplicate of data layer(s) transmitted in one antenna group in at least one of the other antenna groups are received if the UE is configured with “UL full power transmission”=fullpowerMode1.

11. The UE of item 10, wherein, the at least one processor is further configured to cause the UE to: report a capability of supporting fullpowerMode1 for “UL full power transmission”.

12. A processor in a UE for wireless communication, comprising:
at least one controller coupled with at least one memory and configured to cause the processor to:
receive a DCI format 0_1 or 0_2 including a TPMI field, where the TPMI field contains PUSCH transmission scheme information, wherein
the PUSCH transmission scheme information contains data layer split and duplicate information, and precoders used for antenna groups.

13. The processor of item 12, wherein, the data layer split and duplicate information indicates that all antenna groups are used for transmission by duplicating data layer(s) transmitted in one antenna group to be transmitted in at least one of the other antenna groups.

14. The processor of item 13, wherein, all antenna groups transmitting the same set of data layers use a same precoder.

15. The processor of item 13, wherein, each of the antenna groups transmitting the same set of data layers use a different precoder.

16. The processor of item 13, wherein, the duplicated data layers include all or a subset of the data layers transmitted in the one antenna group.

17. The processor of item 13, wherein, if there are 2 antenna groups, both antenna groups transmit the same data layer(s).

18. The processor of item 13, wherein, if there are 4 antenna groups, at least two antenna groups transmit the same data layer(s), and the other antenna group(s) transmit data layer(s) different from the data layer(s) transmitted by the at least two antenna groups.

19. The processor of item 12, wherein, the data layer split and duplicate information and the precoders used for antenna groups are tabulated in a table, and the PUSCH transmission scheme information is an index of the entry in the table.

20. The processor of item 19, wherein, each index is one of TPMIs for normal transmission or TPMIs for full power transmission.

21. The processor of item 20, wherein, the TPMIs for full power transmission by transmitting a duplicate of data layer(s) transmitted in one antenna group in at least one of the other antenna groups are received if the UE is configured with “UL full power transmission”=fullpowerMode1.

22. The processor of item 21, wherein, the at least one controller is further configured to cause the processor to: report a capability of supporting fullpowerMode1 for “UL full power transmission”.

23. A method performed by a user equipment (UE), the method comprising:
receiving a DCI format 0_1 or 0_2 including a TPMI field, where the TPMI field contains PUSCH transmission scheme information, wherein,
the PUSCH transmission scheme information contains data layer split and duplicate information, and precoders used for antenna groups.

24. The method of item 23, wherein, the data layer split and duplicate information indicates that all antenna groups are used for transmission by duplicating data layer(s) transmitted in one antenna group to be transmitted in at least one of the other antenna groups.

25. The method of item 24, wherein, all antenna groups transmitting the same set of data layers use a same precoder.

26. The method of item 24, wherein, each of the antenna groups transmitting the same set of data layers use a different precoder.

27. The method of item 24, wherein, the duplicated data layers include all or a subset of the data layers transmitted in the one antenna group.

28. The method of item 24, wherein, if there are 2 antenna groups, both antenna groups transmit the same data layer(s).

29. The method of item 24, wherein, if there are 4 antenna groups, at least two antenna groups transmit the same data layer(s), and the other antenna group(s) transmit data layer(s) different from the data layer(s) transmitted by the at least two antenna groups.

30. The method of item 23, wherein, the data layer split and duplicate information and the precoders used for antenna groups are tabulated in a table, and the PUSCH transmission scheme information is an index of the entry in the table.

31. The method of item 30, wherein, each index is one of TPMIs for normal transmission or TPMIs for full power transmission.

32. The method of item 31, wherein, the TPMIs for full power transmission by transmitting a duplicate of data layer(s) transmitted in one antenna group in at least one of the other antenna groups are received if the UE is configured with “UL full power transmission”-fullpowerMode1.

33. The method of item 32, further comprising: reporting a capability of supporting fullpowerMode1 for “UL full power transmission”.

34. A base station for wireless communication, comprising:
at least one memory; and
at least one processor coupled with the at least one memory and configured to cause the base station to:
transmit a DCI format 0_1 or 0_2 including a TPMI field, where the TPMI field contains PUSCH transmission scheme information, wherein,
the PUSCH transmission scheme information contains data layer split and duplicate information, and precoders used for antenna groups.

35. The base station of item 34, wherein, the data layer split and duplicate information indicates that all antenna groups are used for transmission by transmitting a duplicate of data layer(s) transmitted in one antenna group in at least one of the other antenna groups.

36. The base station of item 35, wherein, all antenna groups transmitting the same set of data layers use a same precoder.

37. The base station of item 35, wherein, each of the antenna groups transmitting the same set of data layers use a different precoder.

38. The base station of item 35, wherein, the duplicated data layers include all or a subset of the data layers transmitted in the one antenna group.

39. The base station of item 35, wherein, if there are 2 antenna groups, both antenna groups transmit the same data layer(s).

40. The base station of item 35, wherein, if there are 4 antenna groups, at least two antenna groups transmit the same data layer(s), and the other antenna group(s) transmit data layer(s) different from the data layer(s) transmitted by the at least two antenna groups.

41. The base station of item 34, wherein, the data layer split and duplicate information and the precoders used for antenna groups are tabulated in a table, and the PUSCH transmission scheme information is an index of the entry in the table.

42. The base station of item 41, wherein, each index is one of TPMIs for normal transmission or TPMIs for full power transmission.

43. The base station of item 42, wherein, the at least one processor is further configured to cause the base station to: receive a capability of supporting fullpowerMode1 for “UL full power transmission”.

44. The base station of item 43, wherein, the TPMIs for full power transmission by transmitting a duplicate of data layer(s) transmitted in one antenna group in at least one of the other antenna groups are transmitted if a UE is configured with “UL full power transmission”=fullpowerMode1.

45. A processor in a base station for wireless communication, comprising:
at least one controller coupled with at least one memory and configured to cause the processor to:
transmit a DCI format 0_1 or 0_2 including a TPMI field, where the TPMI field contains PUSCH transmission scheme information, wherein,
the PUSCH transmission scheme information contains data layer split and duplicate information, and precoders used for antenna groups.

46. The processor of item 45, wherein, the data layer split and duplicate information indicates that all antenna groups are used for transmission by transmitting a duplicate of data layer(s) transmitted in one antenna group in at least one of the other antenna groups.

47. The processor of item 46, wherein, all antenna groups transmitting the same set of data layers use a same precoder.

48. The processor of item 46, wherein, each of the antenna groups transmitting the same set of data layers use a different precoder.

49. The processor of item 46, wherein, the duplicated data layers include all or a subset of the data layers transmitted in the one antenna group.

50. The processor of item 46, wherein, if there are 2 antenna groups, both antenna groups transmit the same data layer(s).

51. The processor of item 46, wherein, if there are 4 antenna groups, at least two antenna groups transmit the same data layer(s), and the other antenna group(s) transmit data layer(s) different from the data layer(s) transmitted by the at least two antenna groups.

52. The processor of item 45, wherein, the data layer split and duplicate information and the precoders used for antenna groups are tabulated in a table, and the PUSCH transmission scheme information is an index of the entry in the table.

53. The processor of item 52, wherein, each index is one of TPMIs for normal transmission or TPMIs for full power transmission.

54. The processor of item 53, wherein, the at least one controller is further configured to cause the processor to: receive a capability of supporting fullpowerMode1 for “UL full power transmission”.

55. The processor of item 54, wherein, the TPMIs for full power transmission by transmitting a duplicate of data layer(s) transmitted in one antenna group in at least one of the other antenna groups are transmitted if a UE is configured with “UL full power transmission”=fullpowerMode1.

56. A method performed by a base station, the method comprising:
transmit a DCI format 0_1 or 0_2 including a TPMI field, where the TPMI field contains PUSCH transmission scheme information, wherein,
the PUSCH transmission scheme information contains data layer split and duplicate information, and precoders used for antenna groups.

57. The method of item 56, wherein, the data layer split and duplicate information indicates that all antenna groups are used for transmission by transmitting a duplicate of data layer(s) transmitted in one antenna group in at least one of the other antenna groups

58. The method of item 57, wherein, all antenna groups transmitting the same set of data layers use a same precoder.

59. The method of item 57, wherein, each of the antenna groups transmitting the same set of data layers use a different precoder.

60. The method of item 57, wherein, the duplicated data layers include all or a subset of the data layers transmitted in the one antenna group.

61. The method of item 57, wherein, if there are 2 antenna groups, both antenna groups transmit the same data layer(s).

62. The method of item 57, wherein, if there are 4 antenna groups, at least two antenna groups transmit the same data layer(s), and the other antenna group(s) transmit data layer(s) different from the data layer(s) transmitted by the at least two antenna groups.

63. The method of item 56, wherein, the data layer split and duplicate information and the precoders used for antenna groups are tabulated in a table, and the PUSCH transmission scheme information is an index of the entry in the table.

64. The method of item 63, wherein, each index is one of TPMIs for normal transmission or TPMIs for full power transmission.

65. The method of item 64, further comprising: receiving a capability of supporting fullpowerMode1 for “UL full power transmission”.

66. The method of item 65, wherein, the TPMIs for full power transmission by transmitting a duplicate of data layer(s) transmitted in one antenna group in at least one of the other antenna groups are transmitted if a UE is configured with “UL full power transmission”=fullpowerMode1.

FIG. 6 illustrates a flowchart of a method 600 in accordance with aspects of the present disclosure. The operations of the method may be implemented by a UE as described herein. In some implementations, the UE may execute a set of instructions to control the function elements of the UE to perform the described functions.

At 602, receiving a DCI format 0_1 or 0_2 including a TPMI field, where the TPMI field contains PUSCH transmission scheme information, wherein, the PUSCH transmission scheme information contains data layer split and duplicate information, and precoders used for antenna groups.

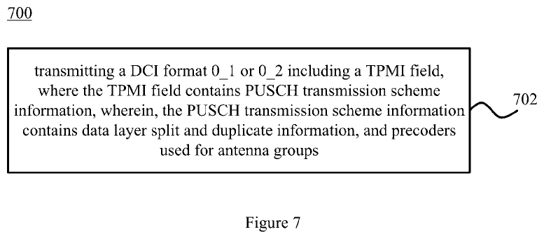

FIG. 7 illustrates a flowchart of a method 700 in accordance with aspects of the present disclosure. The operations of the method may be implemented by a NE as described herein. In some implementations, the NE may execute a set of instructions to control the function elements of the NE to perform the described functions.

At 702, transmitting a DCI format 0_1 or 0_2 including a TPMI field, where the TPMI field contains PUSCH transmission scheme information, wherein, the PUSCH transmission scheme information contains data layer split and duplicate information, and precoders used for antenna groups.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

### APPENDIX

TABLE 6.3.1.5-1
Precoding matrix W for single-layer transmission using two
antenna ports.

| | W | | | | | | | |
|---|---|---|---|---|---|---|---|---|
| TPMI index | (ordered from left to right in increasing order of TPMI index) | | | | | | | |
| 0-5 | $\frac{1}{\sqrt{2}} [ \begin{matrix}1 \\ 0\end{matrix} ]$ | $\frac{1}{\sqrt{2}} [ \begin{matrix}0 \\ 1\end{matrix} ]$ | $\frac{1}{\sqrt{2}} [ \begin{matrix}1 \\ 1\end{matrix} ]$ | $\frac{1}{\sqrt{2}} [ \begin{matrix}1 \\ - 1\end{matrix} ]$ | $\frac{1}{\sqrt{2}} [ \begin{matrix}1 \\ j\end{matrix} ]$ | $\frac{1}{\sqrt{2}} [ \begin{matrix}1 \\ - j\end{matrix} ]$ | — | — |

TABLE 6.3.1.5-2
Precoding matrix W for single-layer transmission using four
antenna ports with transform precoding enabled.

| | W | | | | | | | |
|---|---|---|---|---|---|---|---|---|
| TPMI index | (ordered from left to right in increasing order of TPMI index) | | | | | | | |
| 0-7 | $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |
| 8-15 | $\frac{1}{2} [ \begin{matrix}0 \\ 1 \\ 0 \\ 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ j\end{matrix} ]$ | $\frac{1}{2} [ \begin{matrix}0 \\ 1 \\ 0 \\ - j\end{matrix} ]$ | $\frac{1}{2} [ \begin{matrix}1 \\ 1 \\ 1 \\ - 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ 1\end{matrix} ]$ | $\frac{1}{2} [ \begin{matrix}1 \\ 1 \\ - j \\ - j\end{matrix} ]$ |
| 16-23 | $\frac{1}{2} [ \begin{matrix}1 \\ j \\ 1 \\ j\end{matrix} ]$ | $\frac{1}{2} [ \begin{matrix}1 \\ j \\ j \\ 1\end{matrix} ]$ | $\frac{1}{2} [ \begin{matrix}1 \\ j \\ - 1 \\ - j\end{matrix} ]$ | $\frac{1}{2} [ \begin{matrix}1 \\ j \\ - j \\ - 1\end{matrix} ]$ | $\frac{1}{2} [ \begin{matrix}1 \\ - 1 \\ 1 \\ 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ - 1\end{matrix} ]$ | $\frac{1}{2} [ \begin{matrix}1 \\ - 1 \\ - j \\ j\end{matrix} ]$ |
| 24-27 | $\frac{1}{2} [ \begin{matrix}1 \\ - j \\ 1 \\ - j\end{matrix} ]$ | $\frac{1}{2} [ \begin{matrix}1 \\ - j \\ j \\ - 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ 1\end{matrix} ]$ | — | — | — | — |

TABLE 6.3.1.5-3
Precoding matrix W for single-layer transmission using four
antenna ports with transform precoding disabled.

| | W | | | | | | | |
|---|---|---|---|---|---|---|---|---|
| TPMI index | (ordered from left to right in increasing order of TPMI index) | | | | | | | |
| 0-7 | $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |
| 8-15 | $\frac{1}{2} [ \begin{matrix}0 \\ 1 \\ 0 \\ 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ j\end{matrix} ]$ | $\frac{1}{2} [ \begin{matrix}0 \\ 1 \\ 0 \\ - j\end{matrix} ]$ | $\frac{1}{2} [ \begin{matrix}1 \\ 1 \\ 1 \\ 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ - 1\end{matrix} ]$ | $\frac{1}{2} [ \begin{matrix}1 \\ 1 \\ - j \\ - j\end{matrix} ]$ |
| 16-23 | $\frac{1}{2} [ \begin{matrix}1 \\ j \\ 1 \\ j\end{matrix} ]$ | $\frac{1}{2} [ \begin{matrix}1 \\ j \\ j \\ - 1\end{matrix} ]$ | $\frac{1}{2} [ \begin{matrix}1 \\ j \\ - 1 \\ - j\end{matrix} ]$ | $\frac{1}{2} [ \begin{matrix}1 \\ j \\ - j \\ 1\end{matrix} ]$ | $\frac{1}{2} [ \begin{matrix}1 \\ - 1 \\ 1 \\ - 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ 1\end{matrix} ]$ | $\frac{1}{2} [ \begin{matrix}1 \\ - 1 \\ - j \\ j\end{matrix} ]$ |
| 24-27 | $\frac{1}{2} [ \begin{matrix}1 \\ - j \\ 1 \\ - j\end{matrix} ]$ | $\frac{1}{2} [ \begin{matrix}1 \\ - j \\ j \\ 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ - 1\end{matrix} ]$ | — | — | — | — |

TABLE 6.3.1.5-4
Precoding matrix W for two-layer transmission using two
antenna ports with transform precoding disabled.

| | W | | |
|---|---|---|---|
| TPMI index | (ordered from left to right in increasing order of TPMI index) | | |
| 0-2 | $\frac{1}{\sqrt{2}} [ \begin{matrix}1 & 0 \\ 0 & 1\end{matrix} ]$ | $\frac{1}{2} [ \begin{matrix}1 & 1 \\ 1 & - 1\end{matrix} ]$ | $\frac{1}{2} [ \begin{matrix}1 & 1 \\ j & - j\end{matrix} ]$ |

TABLE 6.3.1.5-5
Precoding matrix W for two-layer transmission using four
antenna ports with transform precoding disabled.

| | W | | | |
|---|---|---|---|---|
| TPMI index | (ordered from left to right in increasing order of TPMI index) | | | |
| 0-3 | $\frac{1}{2} [ \begin{matrix}1 & 0 \\ 0 & 1 \\ 0 & 0 \\ 0 & 0\end{matrix} ]$ | $\frac{1}{2} [ \begin{matrix}1 & 0 \\ 0 & 0 \\ 0 & 1 \\ 0 & 0\end{matrix} ]$ | $\frac{1}{2} [ \begin{matrix}1 & 0 \\ 0 & 0 \\ 0 & 0 \\ 0 & 1\end{matrix} ]$ | $\frac{1}{2} [ \begin{matrix}0 & 0 \\ 1 & 0 \\ 0 & 1 \\ 0 & 0\end{matrix} ]$ |
| 4-7 | $\frac{1}{2} [ \begin{matrix}0 & 0 \\ 1 & 0 \\ 0 & 0 \\ 0 & 1\end{matrix} ]$ | $\frac{1}{2} [ \begin{matrix}0 & 0 \\ 0 & 0 \\ 1 & 0 \\ 0 & 1\end{matrix} ]$ | $\frac{1}{2} [ \begin{matrix}1 & 0 \\ 0 & 1 \\ 1 & 0 \\ 0 & - j\end{matrix} ]$ | $\frac{1}{2} [ \begin{matrix}1 & 0 \\ 0 & 1 \\ 1 & 0 \\ 0 & j\end{matrix} ]$ |
| 8-11 | $\frac{1}{2} [ \begin{matrix}1 & 0 \\ 0 & 1 \\ - j & 0 \\ 0 & 1\end{matrix} ]$ | $\frac{1}{2} [ \begin{matrix}1 & 0 \\ 0 & 1 \\ - j & 0 \\ 0 & - 1\end{matrix} ]$ | $\frac{1}{2} [ \begin{matrix}1 & 0 \\ 0 & 1 \\ - 1 & 0 \\ 0 & - j\end{matrix} ]$ | $\frac{1}{2} [ \begin{matrix}1 & 0 \\ 0 & 1 \\ - 1 & 0 \\ 0 & j\end{matrix} ]$ |
| 12-15 | $\frac{1}{2} [ \begin{matrix}1 & 0 \\ 0 & 1 \\ j & 0 \\ 0 & 1\end{matrix} ]$ | $\frac{1}{2} [ \begin{matrix}1 & 0 \\ 0 & 1 \\ j & 0 \\ 0 & - 1\end{matrix} ]$ | $\frac{1}{2 \sqrt{2}} [ \begin{matrix}1 & 1 \\ 1 & 1 \\ 1 & - 1 \\ 1 & - 1\end{matrix} ]$ | $\frac{1}{2 \sqrt{2}} [ \begin{matrix}1 & 1 \\ 1 & 1 \\ j & - j \\ j & - j\end{matrix} ]$ |
| 16-19 | $\frac{1}{2 \sqrt{2}} [ \begin{matrix}1 & 1 \\ j & j \\ 1 & - 1 \\ j & - j\end{matrix} ]$ | $\frac{1}{2 \sqrt{2}} [ \begin{matrix}1 & 1 \\ j & j \\ j & - j \\ - 1 & 1\end{matrix} ]$ | $\frac{1}{2 \sqrt{2}} [ \begin{matrix}1 & 1 \\ - 1 & - 1 \\ 1 & - 1 \\ - 1 & 1\end{matrix} ]$ | $\frac{1}{2 \sqrt{2}} [ \begin{matrix}1 & 1 \\ - 1 & - 1 \\ j & - j \\ - j & j\end{matrix} ]$ |
| 20-21 | $\frac{1}{2 \sqrt{2}} [ \begin{matrix}1 & 1 \\ - j & - j \\ 1 & - 1 \\ - j & j\end{matrix} ]$ | $\frac{1}{2 \sqrt{2}} [ \begin{matrix}1 & 1 \\ - j & - j \\ j & - j \\ 1 & - 1\end{matrix} ]$ | — | — |

TABLE 6.3.1.5-6
Precoding matrix W for three-layer transmission using four
antenna ports with transform precoding disabled.

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 \\ 0 & 1 & 0 \\ 0 & 0 & 1 \\ 0 & 0 & 0\end{matrix} ]$ | $\frac{1}{2} [ \begin{matrix}1 & 0 & 0 \\ 0 & 1 & 0 \\ 1 & 0 & 0 \\ 0 & 0 & 1\end{matrix} ]$ | $\frac{1}{2} [ \begin{matrix}1 & 0 & 0 \\ 0 & 1 & 0 \\ - 1 & 0 & 0 \\ 0 & 0 & 1\end{matrix} ]$ | $\frac{1}{2 \sqrt{3}} [ \begin{matrix}1 & 1 & 1 \\ 1 & - 1 & 1 \\ 1 & 1 & - 1 \\ 1 & - 1 & - 1\end{matrix} ]$ |
| 4-6 | $\frac{1}{2 \sqrt{3}} [ \begin{matrix}1 & 1 & 1 \\ 1 & - 1 & 1 \\ j & j & - j \\ j & - j & - j\end{matrix} ]$ | $\frac{1}{2 \sqrt{3}} [ \begin{matrix}1 & 1 & 1 \\ - 1 & 1 & - 1 \\ 1 & 1 & - 1 \\ - 1 & 1 & 1\end{matrix} ]$ | $\frac{1}{2 \sqrt{3}} [ \begin{matrix}1 & 1 & 1 \\ - 1 & 1 & - 1 \\ j & j & - j \\ - j & j & j\end{matrix} ]$ | — |

TABLE 6.3.1.5-7
Precoding matrix W for four-layer transmission using four
antenna ports with transform precoding disabled.

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 & 0 \\ 0 & 1 & 0 & 0 \\ 0 & 0 & 1 & 0 \\ 0 & 0 & 0 & 1\end{matrix} ]$ | $\frac{1}{2 \sqrt{2}} [ \begin{matrix}1 & 1 & 0 & 0 \\ 0 & 0 & 1 & 1 \\ 1 & - 1 & 0 & 0 \\ 0 & 0 & 1 & - 1\end{matrix} ]$ | $\frac{1}{2 \sqrt{2}} [ \begin{matrix}1 & 1 & 0 & 0 \\ 0 & 0 & 1 & 1 \\ j & - j & 0 & 0 \\ 0 & 0 & j & - j\end{matrix} ]$ | $\frac{1}{4} [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ]$ |
| 4 | $\frac{1}{4} [ \begin{matrix}1 & 1 & 1 & 1 \\ 1 & - 1 & 1 & - 1 \\ j & j & - j & - j \\ j & - j & - j & j\end{matrix} ]$ | | | |

1. A user equipment (UE) for wireless communication, comprising:
at least one memory; and
at least one processor coupled with the at least one memory and configured to cause the UE to:
receive a downlink control information (DCI) format 0_1 or 0_2 including a transmit precoding matrix indicator (TPMI) field, where the TPMI field contains physical uplink shared channel (PUSCH) transmission scheme information, wherein the PUSCH transmission scheme information contains data layer split and duplicate information, and precoders used for antenna groups.

2. The UE of claim 1, wherein the data layer split and duplicate information indicates that all antenna groups are used for transmission by duplicating data layer(s) transmitted in one antenna group to be transmitted in at least one of the other antenna groups.

3. The UE of claim 2, wherein all antenna groups transmitting the same set of data layers use a same precoder.

4. The UE of claim 2, wherein each of the antenna groups transmitting the same set of data layers use a different precoder.

5. The UE of claim 2, wherein the duplicated data layers include all or a subset of the data layers transmitted in the one antenna group.

6. The UE of claim 2, wherein, in response to there being 2 antenna groups, both antenna groups transmit the same data layer(s).

7. The UE of claim 2, wherein, in response to there being 4 antenna groups, at least two antenna groups transmit the same data layer(s), and the other antenna group(s) transmit data layer(s) different from the data layer(s) transmitted by the at least two antenna groups.

8. The UE of claim 1, wherein:
the data layer split and duplicate information and the precoders used for antenna groups are tabulated in a table, and
the PUSCH transmission scheme information is an index of an entry in the table.

9. The UE of claim 8, wherein each index is one of TPMIs for normal transmission or TPMIs for full power transmission.

10. The UE of claim 9, wherein the TPMIs for full power transmission by transmitting a duplicate of data layer(s) transmitted in one antenna group in at least one of the other antenna groups are received if the UE is configured with “UL full power transmission”=fullpowerMode1.

11. The UE of claim 10, wherein the at least one processor is configured to cause the UE to:
report a capability of supporting fullpowerMode1 for “UL full power transmission”.

12. A processor for wireless communication, comprising:
at least one controller coupled with at least one memory and configured to cause the processor to:
receive a DCI format 0_1 or 0_2 including a TPMI field, where the TPMI field contains PUSCH transmission scheme information, wherein,
the PUSCH transmission scheme information contains data layer split and duplicate information, and precoders used for antenna groups.

13. A method performed by a user equipment (UE), the method comprising:
receiving a downlink control information (DCI) format 0_1 or 0_2 including a transmit precoding matrix indicator (TPMI) field, where the TPMI field contains physical uplink shared channel (PUSCH) transmission scheme information, wherein the PUSCH transmission scheme information contains data layer split and duplicate information, and precoders used for antenna groups.

14. A base station for wireless communication, comprising:
at least one memory; and
at least one processor coupled with the at least one memory and configured to cause the base station to:
transmit a downlink control information (DCI) format 0_1 or 0_2 including a transmit precoding matrix indicator (TPMI) field, where the TPMI field contains physical uplink shared channel (PUSCH) transmission scheme information, wherein the PUSCH transmission scheme information contains data layer split and duplicate information, and precoders used for antenna groups.

15. The base station of claim 14, wherein the data layer split and duplicate information indicates that all antenna groups are used for transmission by transmitting a duplicate of data layer(s) transmitted in one antenna group in at least one of the other antenna groups.

16. The base station of claim 15, wherein all antenna groups transmitting the same set of data layers use a same precoder.

17. The base station of claim 15, wherein each of the antenna groups transmitting the same set of data layers use a different precoder.

18. The base station of claim 15, wherein the duplicate of the data layer(s) include all or a subset of the data layers transmitted in the one antenna group.

19. The base station of claim 15, wherein, in response to there being 2 antenna groups, both antenna groups transmit the same data layer(s).

20. The base station of claim 15, wherein, in response to there being 4 antenna groups, at least two antenna groups transmit the same data layer(s), and the other antenna group(s) transmit data layer(s) different from the data layer(s) transmitted by the at least two antenna groups.
